(19) United States
(12) Patent Application Publication
(10) Pub. No.: US 2010/0248575 A1
(43) Pub. Date: Sep. 30, 2010

(54) FIBERS, PARTICULARLY NONWOVEN FABRIC BASED ON THERMOPLASTIC POLYURETHANE

(75) Inventor: Hauke Malz, Diepholz (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/513,857

(22) PCT Filed: Nov. 5, 2007
(86) PCT No.: PCT/EP07/61860

§ 371 Date: May 7, 2009

(30) Foreign Application Priority Data
Nov. 10, 2006 (EP) 06123833.3

(51) Int. Cl. C08L 75/04; D04H 13/00; C08K 3/22; C08K 3/32; B29C 47/00

(52) U.S. Cl. 442/327; 524/590; 524/430; 524/431; 524/414; 524/433; 264/176.1

(57) ABSTRACT

The thermoplastic polyurethane comprises an inorganic additive, at least 70% of the particles of the inorganic additive having a maximum particle diameter smaller than 75% of the fiber diameter of the thermoplastic polyurethane.

This invention concerns fibers, in particular nonwoven comprising fibers based on thermoplastic polyurethane comprising an inorganic additive, at least 70%, preferably at least 90% and more preferably at least 99.9% of the individual particles of the inorganic additive having a maximum particle diameter smaller than 75%, preferably smaller than 60% and more preferably smaller than 50% of the fiber diameter of the thermoplastic polyurethane. The present invention also concerns processes for producing such fibers or nonwovens.

Fibers based on thermoplastic polyurethane, hereinafter also referred to as TPU, and also wovens, knits or nonwovens comprising these fibers are common general knowledge and are widely commercially available. A disadvantageous aspect of using TPU for production of fibers is the material's sticking and blocking, which makes it impossible for wound packages to be unwound at the high speeds needed for textile further-processing operations. A current way of avoiding this problem is to use spin oils, based on silicone for example, in concentrations of 4 to 8%. This has the disadvantage that the silicone oil has to be washed off again in a subsequent processing step. This is very costly, inconvenient and also environmentally incompatible because of the high water consumption and the large amount of detergents and emulsifiers.

This disadvantage in the surface constitution of TPU also presents when TPU is used for nonwovens. Nonwovens are non-woven textile structures produced by adhering or bonding or adhering and bonding fibers together by mechanical, chemical, thermal or solvent-engineering methods or any combination thereof. Polymeric nonwovens are mainly produced in continuous processes. The meltblown and spunbond processes may be mentioned here in particular. In these processes, the polymer is melted in an extruder and pumped to a spinning manifold. State of the art nonwoven processes operate at high throughputs and utilize spinning manifolds up to 5 m in width for continuous production of the nonwovens.

The production of nonwovens by the meltblown and spunbond processes utilizes polypropylene and polyester in the main. However, nonwovens produced from these plastics are not elastic. This is why there have been efforts in recent years to use TPU to make nonwovens. Thermoplastic polyurethanes are polyurethanes which, when repeatedly heated and cooled in the temperature range typical for processing and using the material of construction, remain thermoplastic. Thermoplastic in relation to a polyurethane describes the polyurethane's property of, in a temperature range between 150° C. and 300° C. typical for the polyurethane, repeatedly softening when hot and hardening when cold and, in the softened state, repeatedly being moldable into intermediate or final articles as a molded, extruded or formed part. Nonwovens based on TPUs are notable for very high elasticity, good recovery, low residual extension and tensile strength.

However, there is a disadvantageous aspect to using TPU for nonwovens in that, when in direct contact with human skin for several hours, the wear comfort is perceived as rubberlike and unpleasant. This is why TPU nonwovens are frequently produced in the bicomponent mode. Bicomponent means that a TPU core is surrounded with a polyolefin sheath for example. This gives a smooth non-blocking surface. However, the bicomponent process is very inefficient and hence costly. Thus, two of every part of the equipment are required, i.e., two separate extruders, two separate melt lines, pumps, etc. In addition, the spinneret dies are highly engineered and hence costly. Alternatively, a sandwich can be produced from a TPU nonwoven and two outer polyolefin nonwovens. But this too is a costly and complicated construction and, what is more, there are problems with the adhesion of polyolefin to TPU.

To reduce TPU blocking, additives such as polyolefins or polystyrenes may be incorporated in the TPU. However, these additives reduce the spinability of the fibers. As the fiber undergoes drawing, large forces act on the TPU melt. A weak point in the threadline, for example an inhomogeneously dissolved additive, will cause the threadline to break and the continuous spinning operation to collapse.

It is an object of the present invention to provide TPU-based fibers and particularly nonwovens whose surface has less tendency to stick and block. These fibers should have pleasant haptics and very good processing properties, in particular an improved draw ratio. It would be particularly preferable to develop lightfast TPU nonwovens that have a pleasant textile hand, are readily processable and have good mechanical properties, in particular a good breaking extension.

We have found that these objects are achieved by the fibers set forth at the beginning, in particular nonwovens comprising these fibers.

The TPU used for the fibers and nonwovens of the present invention has optimized surface properties due to the addition of the inorganic additives in the specific particle size; more particularly, the material is less prone to sticking and blocking and has improved haptics. The present invention's size distribution of the inorganic particles means that the mechanical property portfolio is not significantly adversely affected by the addition of the additives. More particularly, incorporation of the additive has led to a significant increase in the maximum draw ratio. It is a further advantage of the additives according to the present invention that their particle size or particle size distribution is process independent, i.e., does not change significantly during the processing step of the TPU. This constitutes an immense advantage over, for example, polymeric additives such as polyolefins and polystyrenes. These may change their particle size during processing due to coalescence phenomena for example.

The inorganic additives have the present invention's particle size and particle size distribution. The particles may be based on customary inorganic materials, for example silicon compounds such as silicon dioxide and silicates, silica gel, metal oxides, carbonates, borates, boron nitrides, talcum, rock flour, zeolites, montmorillonites, aluminosilicates. Examples of inorganic additives are to be found in Plastics additive handbook Cal Hanser Verlag, Munich, ISBN 3-446-21654-5, pages 587 ff. The inorganic additive preferably comprises the following constituents and more preferably the additive consists of the following constituents:

between 90% by weight and 95% by weight of SiO₂
between 1% by weight and 5% by weight of Al₂O₃
between 1% by weight and 5% by weight of Fe₂O₃
between 0.1% by weight and 1% by weight of P₂O₅
between 0.1% by weight and 1% by weight of TiO₂
between 0.1% by weight and 2% by weight of CaO
between 0.1% by weight and 2% by weight of MgO
between 0.01% by weight and 3% by weight of Na₂O
between 0.01% by weight and 3% by weight of K₂O.

Preference is given to using inorganic additives based on silicon, in particular silicates. Particular preference is given to using inorganic additives available under the brand Celite® Superfine Superfloss from Celite Corporation USA.

Preferably, at least 90% of the particles of the additive have a maximum diameter below 15 μm.

The weight fraction of inorganic additive in the thermoplastic polyurethane may be preferably between 0.1% by weight and 5% by weight, more preferably between 0.5% by weight and 3% by weight and especially between 0.75% by weight and 2% by weight, all based on the total weight of the thermoplastic polyurethane including the inorganic additive. The inorganic additive may be admixed to one of the starting materials for producing the TPU, so that the TPU is produced in the presence of the inorganic additive, or else it may for example be admixed to the TPU as a concentrate. In this case, the concentrate and the TPU are homogeneously mixed in the molten state directly before spinning for example to thereby incorporate the inorganic additive in the TPU. The additive can also be added directly to the TPU in the course of production or processing. Addition via a concentrate is preferred.

It has been determined that, surprisingly, the additives of the present invention, in particular the silicon-based additives of the present invention, in particular Celite Superfine Superfloss® not only reduce the blocking tendency of TPU fibers but also improve their spinability, i.e., the draw ratio to which the TPU fibers can be drawn increases by more than 10% preferably by more than 100%. Draw ratio refers to the ratio of the speed of the TPU melt in the die to the withdrawal speed. A high draw ratio is of particular importance for the economics of fiber- or nonwoven-producing operations. A higher draw ratio means that for a given die geometry the throughput can be increased (higher speed in the die) without an increase in filament thickness. Conversely, a higher draw ratio for a given withdrawal speed means that the die diameter can be increased without increase in the filament diameter. This also increases the throughput.

The present invention thus also provides a process for producing fibers based on thermoplastic polyurethane, which comprises processing a thermoplastic polyurethane comprising an inorganic additive, at least 70%, preferably at least 90% and more preferably at least 99.9% of the particles of the inorganic additive having a maximum particle diameter smaller than 75%, preferably smaller than 60% and more preferably smaller than 50% of the fiber diameter of the thermoplastic polyurethane, by melt spinning to form fiber.

The production of fibers based on thermoplastic polyurethanes is common general knowledge and has been extensively described. Generally known TPUs can be used, preferably those based on aromatic isocyanates. When the fiber is a melt spun spandex, it is preferable to use a TPU having a Shore hardness between 70 Shore A and 90 Shore A and more preferably between 75 Shore A to 85 Shore A.

In one preferred embodiment, the TPU is processed into fibers together with a crosslinker comprising isocyanate groups. Appropriate crosslinkers and also their production and processing is described in EP-A 922 719. Useful crosslinkers include in particular those described in EP-B 922 719 at page 3 paragraph [0011]. The crosslinkers may be based on aliphatic and/or aromatic isocyanates, preferably on aromatic isocyanates. The crosslinkers based on isocyanate-containing prepolymers are preferably used in concentrations between 1% and 30% by weight, more preferably between 5% and 25% by weight and in particular between 10% and 15% by weight, all based on the total weight of the TPU inclusive of crosslinker.

Fiber linear densities are preferably between 5 and 3000 dtex, more preferably between 10 and 250 dtex and in particular between 15 and 78 dtex. One dtex indicates that 10 km of fiber weighs 1 g.

The residual extension of the fibers is preferably <25%, more preferably <20%, in particular <12%. Residual extension is measured by stretching the fiber to 350%. The fiber is then allowed to relax and stretched again to 350%. After the fiber has been allowed to relax a second time, the residual extension is measured as the increase in the length of the fiber in % of the original length of the fiber.

Thermoplastic polyurethanes, also referred to herein as TPUs, and processes for their production are common general knowledge. In general, TPUs are produced by reaction of (a) isocyanates with (b) isocyanate-reactive compounds, typically having a molecular weight (M_{w}) in the range from 500 to 10 000, preferably in the range from 500 to 5000 and more preferably in the range from 800 to 3000, and (c) chain extenders having a molecular weight in the range from 50 to 499 if appropriate in the presence of (d) catalysts and/or (e) customary additives.

In what follows, the starting components of the polyurethanes and processes for producing the polyurethanes are described by way of example. The components (a), (b), (c) and also if appropriate (d) and/or (e) customarily used in the preparation of polyurethanes will now be described by way of example:

Useful organic isocyanates (a) include commonly known aromatic, aliphatic, cycloaliphatic and/or araliphatic isocyanates, preferably diisocyanates, examples being 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethyldiphenyl diisocyanate, 1,2-diphenylethane diisocyanate and/or phenylene diisocyanate, tri-, tetra-, penta-, hexa-, hepta- and/or octamethylene diisocyanate, 2-methylpentamethylene 1,5-diisocyanate, 2-ethylbutylene 1,4-diisocyanate, 1,5-pentamethylene diisocyanate, 1,4-butylene diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, more preferably 2,2′-, 2,4′- and/or 4,4′-diphenylmethane diisocyanate (MDI), 1,5-naphthylene diisocyanate (NDI), 2,4- and/or 2,6-tolylene diisocyanate (TDI), hexamethylene diisocyanate and/or IPDI, in particular 4,4′-MDI and/or hexamethylene diisocyanate. The nonwovens are preferably based on aliphatic isocyanates, other fibers being typically produced using aromatic isocyanates.

Useful isocyanate-reactive compounds (b) include commonly known isocyanate-reactive compounds, examples being polyesterols, polyetherols and/or polycarbonate diols, which are customarily also subsumed under the term “polyols”, having molecular weights between 500 and 8000, preferably 600 to 6000, especially 800 to less than 3000, and preferably an average functionality of 1.8 to 2.3, preferably 1.9 to 2.2 and especially 2 with regard to isocyanates. Useful polyetherols further include so-called low unsaturation polyetherols. Low unsaturation polyols for the purposes of this invention are in particular polyether alcohols containing less than 0.02 meg/g and preferably less than 0.01 meg/g of unsaturated compounds. Such polyether alcohols are usually prepared by addition of alkylene oxides, in particular ethylene oxide, propylene oxide and mixtures thereof, onto the above-described diols or triols in the presence of high activity catalysts. Examples of such high activity catalysts are cesium hydroxide and multimetal cyanide catalysts, also known as DMC catalysts. Zinc hexacyanocobaltate is a frequently employed DMC catalyst. A DMC catalyst can be left in the polyether alcohol after the reaction, but typically it is removed, for example by sedimentation or filtration. It is further possible to use polybutadiene diols having a molar mass of 500-10 000 g/mol preferably 1000-5000 g/mol, especially 2000-3000 g/mol. TPUs prepared using these polyols can be radiation crosslinked after thermoplastic processing. This leads for example to a better burn-off behavior. Mixtures of various polyols can be used instead of just one polyol. Preference is given to using TPUs based on polyetherol-polyesterol mixtures.

Useful chain extenders (c) include commonly known aliphatic, araliphatic, aromatic and/or cycloaliphatic compounds having a molecular weight in the range from 50 to 499, preferably 2-functional compounds, examples being diamines and/or alkanediols having 2 to 10 carbon atoms in the alkylene radical, in particular 1,3-propanediol, 1,4-butanediol, 1,6-hexanediol and/or di-, tri-, tetra-, penta-, hexa-, hepta-, octa-, nona- and/or decaalkylene glycols having 3 to 8 carbon atoms, preferably the corresponding oligo- and/or polypropylene glycols, including mixtures of chain extenders.

Components a) to c) are more preferably difunctional compounds, i.e., diisocyanates (a), difunctional polyols, preferably polyetherols (b) and difunctional chain extenders, preferably diols.

Useful catalysts (d), which speed in particular the reaction between the NCO groups of the diisocyanates (a) and the hydroxyl groups of the building block components (b) and (c), are customary tertiary amines known in the prior art, for example triethylamine, dimethylcyclohexylamine, N-methylmorpholine, N,N′-dimethylpiperazine, 2-(dimethylaminoethoxy)ethanol, diazabicyclo-(2,2,2)-octane and the like, and also in particular organic metal compounds such as titanic esters, iron compounds such as for example iron(III) acetylacetonate, tin compounds, examples being tin diacetate, tin dioctoate, tin dilaurate or the tin dialkyl salts of aliphatic carboxylic acids such as dibutyltin diacetate, dibutyltin dilaurate or the like. The catalysts are typically used in amounts of 0.0001 to 0.1 part by weight per 100 parts by weight of polyhydroxy compound (b).

As well as the inorganic additives according to the invention, customary auxiliaries and/or additives (e) can also be added to the building block components (a) to (c).

There may be mentioned for example surface-active substances, nucleators, gliding and demolding aids, dyes and pigments, antioxidants, for example against hydrolysis, light, heat or discoloration, flame retardants, reinforcing agents and plasticizers, metal deactivators. In one preferred embodiment, component (e) also includes hydrolysis stabilizers such as for example polymeric and low molecular weight carbodiimides. Preferably, the thermoplastic polyurethane comprises triazole and/or triazole derivative and antioxidants in an amount of 0.1% to 5% by weight based on the total weight of the thermoplastic polyurethane. Useful antioxidants are generally substances that inhibit or prevent unwanted oxidative processes in the plastic to be protected. In general, antioxidants are commercially available. Examples of antioxidants are sterically hindered phenols, aromatic amines, thio synergists, organophosphorus compounds of trivalent phosphorus and Hindered Amine Light Stabilizers. Examples of sterically hindered phenols are to be found in Plastics Additive Handbook, 5^{th} edition, H. Zweifel, ed, Hanser Publishers, Munich, 2001 ([1]), pages 98-107 and pages 116-121. Examples of aromatic amines are to be found in [1] pages 107-108. Examples of thio synergists are given in [1], pages 104-105 and pages 112-113. Examples of phosphites are to be found in [1], pages 109-112. Examples of hindered amine light stabilizers are given in [1], pages 123-136. Phenolic antioxidants are preferred for use. In one preferred embodiment, the antioxidants, in particular the phenolic antioxidants, have a molar mass of greater than 350 g/mol, more preferably greater than 700 g/mol and a maximum molar mass <10 000 g/mol preferably <3000 g/mol. They further preferably have a melting point of less than 180° C. It is further preferable to use antioxidants that are amorphous or liquid.

As well as the specified components a), b) and c) and if appropriate d) and e), chain regulators, customarily having a molecular weight of 31 to 3000, can also be used. Such chain regulators are compounds which have only one isocyanate-reactive functional group, examples being monofunctional alcohols, monofunctional amines and/or monofunctional polyols. Such chain regulators make it possible to adjust flow behavior in the case of TPUs in particular to specific values. Chain regulators can be used in general in an amount of 0 to 5 parts and preferably 0.1 to 1 part by weight based on 100 parts by weight of component b), and by definition come within component (c).

To adjust the hardness of TPUs, the building block components (b) and (c) can be varied within relatively wide molar ratios. Useful are molar ratios of component (b) to total of chain extenders (c) in the range from 10:1 to 1:10 and in particular in the range from 1:1 to 1:4, TPU hardness increasing with increasing (c) content.

The thermoplastic polyurethane employed for fiber production preferably has a melt flow rate (MFR) of 5-100 g/10 min, preferably of 10-80 g/10 min, more preferably of 15-40 g/10 min measured at 200° C. and a test weight of 21.6 kg.

In what follows, particularly the nonwovens comprising the fibers of the present invention will be discussed and particularly the preferred TPUs for the nonwovens and also the processes for their production will be presented.

A nonwoven is a layer, web and/or lap of directionally aligned or randomly disposed fibers, consolidated by friction and/or cohesion and/or adhesion. Nonwovens are also known as non-wovens.

Useful TPUs include all generally known TPUs. Preferably, the thermoplastic polyurethane has a crystallization temperature between 130° C. and 220° C. and is preferably based on aliphatic isocyanates. Determining the crystallization temperature of the preferred thermoplastic polyurethanes is common general knowledge and is preferably effected by DSC (Dynamic Scanning Calorimetry) using a Perkin Elmer DSC 7, the thermoplastic polyurethane being treated according to the following temperature program:

1.) hold at 25° C. for 0.1 min
2.) heat from 25° C. to 100° C. at 40 K/min
3.) hold at 100° C. for 10 min
4.) cool from 100° C. to −80° C. at 20 K/min
5.) hold at −80° C. for 2 min
6.) heat from −80° C. to 230° C. at 20 K/min
7.) hold at 230° C. for 1 min
8.) cool from 230° C. to −80° C. at 20 K/min,
and the crystallization temperature is deemed to be that temperature at which the exothermic heat flux of the sample has a maximum during cooling.

These preferred nonwovens are notable for the thermoplastic polyurethanes used having rapid solidifying characteristics, i.e., a rapid crystallization of the TPU takes place at high temperatures in the course of the cooling of the molten filament and leads to early stabilization of the fiber. This makes it possible to process the product on conventional equipment to obtain a nonwoven having a textile hand. Textile hand means in this context that the haptics of the nonwoven corresponds to those of a woven or knit textile. The opposite of a textile hand would be, for example, a plasticky hand whereby the nonwoven would feel like a plastics film. Preference is also given to nonwoven based on aliphatic TPUs. Aromatic thermoplastic polyurethanes refers to such TPUs as are based on an aromatic isocyanate, for example 4,4′ MDI. Aliphatic TPU refers to such TPUs as are based on aliphatic isocyanates, for example 1,6 HDI. The particularly preferred thermoplastic polyurethanes exhibit optically clear, single-phase melts which solidify rapidly and, as a consequence of the partly crystalline polyester hard phase, form slightly opaque to nontransparent white moldings.

The particularly preferred TPUs are obtainable in particular by reaction of (a) isocyanates with (b1) polyester diols having a melting point above 150° C., (b2) polyether diols and/or polyester diols each having a melting point below 150° C. and a molecular weight of 501 to 8000 g/mol, and also (c) diols having a molecular weight of 62 g/mol to 500 g/mol.

The thermoplastic polyurethane is obtainable particularly preferably by reacting a thermoplastic polyester with a diol (c) and then
(i) reacting the reaction product from (i) comprising (b1) polyester diol having a melting point above 150° C. and also if appropriate (c) diol together with (b2) polyether diols and/or polyester diols each having a melting point below 150° C. and a molecular weight of 501 to 8000 g/mol and also if appropriate further (c) diols having a molecular weight of 62 to 500 g/mol with (a) isocyanate if appropriate in the presence of (d) catalysts and/or (e) auxiliaries.

Corresponding TPUs are generally known from WO 03/014179, products and processes thereof will be exhaustively set out later.

Particularly preferably, the thermoplastic polyurethane has a hardness between 65 Shore A and 95 Shore A and more preferably between 75 Shore A and 85 Shore A.

Paper or articles of manufacture which have been woven, knit, tufted, stitch bonded through incorporation of binding yarns or filaments, or felted by a wet-fulling operation are preferably not treated as nonwovens for the purposes of this invention. In one preferred embodiment, a material is to be deemed a nonwoven for the purposes of this invention when more than 50%, and in particular 60% to 90% of the mass of its fibrous constituent consists of fibers having a length to diameter ratio of more than 300 and in particular of more than 500.

In one preferred embodiment, the diameters of the individual fibers of the nonwoven are in the range from 50 μm to 0.1 μm, preferably in the range from 10 μm to 0.5 μm and especially in the range from 7 μm to 0.5 μm.

In one preferred embodiment, the thickness of the nonwovens is in the range from 0.01 to 5 millimeters (mm), more preferably in the range from 0.1 to 2 mm and even more preferably in the range from 0.15 to 1.5 mm, measured to ISO 9073-2.

In one preferred embodiment, the mass per unit area of the nonwovens is in the range from 5 to 500 g/m², more preferably in the range from 10 to 250 g/m², and even more preferably in the range of 15-150 g/m², measured to ISO 9073-1.

The nonwoven may additionally be mechanically consolidated. Mechanical consolidation may take the form of one-sided or both-sided mechanical consolidation; two-sided mechanical consolidation is preferred.

In addition to the afore-described mechanical consolidation, the nonwoven may further be thermally consolidated. Thermal consolidation may be effected for example by subjecting the nonwoven to a treatment with hot air or by calendering the nonwoven. Calendering the nonwoven is preferred.

In one preferred embodiment, the nonwoven used has a machine direction breaking extension between 20% and 2000%, preferably between 100% and 1000% and especially between 200% and 1000%, measured to DIN EN 12127.

The nonwoven used is based on, i.e., is made using, thermoplastic polyurethane. This is to be understood as meaning that the nonwoven used comprises thermoplastic polyurethane, preferably as an essential constituent. One preferred embodiment utilizes a nonwoven comprising thermoplastic polyurethane in an amount of 60% by weight to 100% by weight, more preferably of more than 80% by weight, and especially more than 97% by weight and in particular preferably 100% by weight, based on the total weight of the nonwoven.

As well as thermoplastic polyurethane, the nonwoven used may further comprise other polymers or auxiliaries, examples being polypropylene, polyethylene and/or polystyrene and/or copolymers of polystyrene such as styrene-acrylonitrile copolymers.

The nonwovens of the present invention are preferably produced using TPUs described in WO 03/014179. These particularly preferred TPUs, which will be exhaustively described hereinbelow, have the advantage that the thermoplastic polyurethanes used have rapid solidifying characteristics, i.e., a very good crystallization at high temperatures of the melt. This makes it possible to process the thermoplastic polyurethanes on conventional equipment to obtain a nonwoven having a textile hand. Textile hand means in this context that the haptics of the nonwoven correspond to those of a woven or knit textile. The opposite of a textile hand would be, for example, a plasticky hand whereby the nonwoven would feel like a plastics film.

These particularly preferred TPUs are preferably obtainable by reaction of (a) isocyanates with (b1) polyester diols having a melting point of above 150° C., (b2) polyether diols and/or polyester dials each having a melting point of below 150° C. and a molecular weight of 501 to 8000 g/mol and also if appropriate (c) dials having a molecular weight of 62 g/mol to 500 g/mol. Particular preference here is given to thermoplastic polyurethanes wherein the molar ratio of dials (c) having a molecular weight of 62 g/mol to 500 g/mol to component (b2) is less than 0.2 and more preferably in the range from 0.1 to 0.01. Particular preference is given to thermoplastic polyurethanes wherein the polyester diols (b1), which preferably have a molecular weight of 1000 g/mol to 5000 g/mol, have the following structural unit (I):

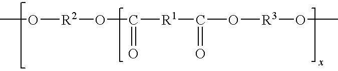

with the following meanings for R1, R2, R3 and X:
R1: carbonaceous scaffold having 2 to 15 carbon atoms, preferably an alkylene group having 2 to 15 carbon atoms and/or a bivalent aromatic radical having 6 to 15 carbon atoms, more preferably having 6 to 12 carbon atoms
R2: optionally branched alkylene group having 2 to 8 carbon atoms, preferably 2 to 6, and more preferably 2 to 4 carbon atoms, especially —CH₂—CH₂— and/or —CH₂—CH₂—CH₂—CH₂—,
R3: optionally branched alkylene group having 2 to 8 carbon atoms, preferably 2 to 6, and more preferably 2 to 4 carbon atoms, especially —CH₂—CH₂— and/or —CH₂—CH₂—CH₂—CH₂—,
X: an integer from 5 to 30. The above preferred melting point and/or the preferred molecular weight are based in this preferred embodiment on the depicted structural unit (I).

“Melting point” herein is to be understood as referring to the maximum of the melting peak of a heating curve measured using a commercially available DSC instrument (for example a DSC 7 from Perkin-Elmer).

The molecular weights reported herein are the number average molecular weights, in [g/mol].

These particularly preferred thermoplastic polyurethanes may preferably be prepared by reacting in a first step (i) a preferably high molecular weight, preferably partly crystalline, thermoplastic polyester with a diol (c) and then in a second reaction (ii) reacting the reaction product from (i) comprising (b1) polyester diol having a melting point of more than 150° C. and also if appropriate (c) diol together with (b2) polyether diols and/or polyester diols each having a melting point of less than 150° C. and a molecular weight of 501 to 8000 g/mol and also if appropriate further (c) diols having a molecular weight of 62 to 500 g/mol with (a) isocyanate if appropriate in the presence of (d) catalysts and/or (e) auxiliaries.

For the reaction (ii), the molar ratio of the diols (c) having a molecular weight of 62 g/mol to 500 g/mol to component (b2) is preferably less than 0.2 and more preferably in the range from 0.1 to 0.01.

Whereas step (i) provides the hard phases for the end product through the polyester used in step (i), the soft phases are constructed through the use of component (b2) in step (ii). The preferred technical teaching is that polyesters having a pronounced, efficiently crystallizing hard phase structure are preferentially melted in a reaction extruder and initially degraded with a low molecular weight diol to form shorter polyesters having free hydroxyl end groups. The originally high crystallization tendency of the polyester is preserved in the process and can subsequently be utilized to obtain, in a rapidly proceeding reaction, TPUs having the advantageous properties, viz high tensile strength values, low abrasion values and, owing to the high and narrow melting range, high heat distortion resistances and low pressure deformation residuals. The preferred process thus has preferably high molecular weight, partly crystalline, thermoplastic polyesters degraded with low molecular weight diols (c) under suitable conditions within a short reaction time to fast-crystallizing polyester diols (b1), which in turn are then incorporated with other polyester diols and/or polyether diols and diisocyanates in high molecular weight polymer chains.

The thermoplastic polyester used, i.e., before reaction (i) with diol (c), preferably has a molecular weight of 15 000 g/mol to 40 000 g/mol and also preferably a melting point of above 160° C. and more preferably in the range from 170° C. to 260° C.

The starting polyester, which is reacted with the diol or diols (c) in step (i) preferably in the molten state more preferably at a temperature of 230° C. to 280° C. preferably for a period of 0.1 min to 4 min, more preferably 0.3 min to 1 min, can be any commonly known, preferably high molecular weight, preferably partly crystalline, thermoplastic polyester, for example in pelletized form. Suitable polyesters are based for example on aliphatic, cycloaliphatic, araliphatic and/or aromatic dicarboxylic acids, for example lactic acid and/or terephthalic acid, and also aliphatic, cycloaliphatic, araliphatic and/or aromatic dialcohols, for example 1,2-ethanediol, 1,4-butanediol and/or 1,6-hexanediol.

Particularly preferred polyesters are: poly-L-lactic acid and/or polyalkylene terephthalate, for example polyethylene terephthalate, polypropylene terephthalate, polybutylene terephthalate, especially polybutylene terephthalate.

Making these esters from the starting materials mentioned is common general knowledge and has been extensively described. Suitable polyesters, moreover, are commercially available.

The thermoplastic polyester is preferably melted at a temperature of 180° C. to 270° C. Reaction (i) with diol (c) is preferably carried out at a temperature of 230° C. to 280° C. and preferably 240° C. to 280° C.

The diol (c) used in step (i) for reaction with the thermoplastic polyester and if appropriate in step (ii) can be any commonly known diol having a molecular weight of 62 to 500 g/mol, for example those mentioned later, examples being ethylene glycol, 1,3-propanediol, 1,4-butanediol, 1,5-pentanediol, 1,6-hexanediol, heptanediol, octanediol, preferably 1,4-butanediol and/or 1,2-ethanediol.

The weight ratio of thermoplastic polyester to diol (c) in step (i) is typically in the range from 100:1.0 to 100:10 and preferably in the range from 100:1.5 to 100:8.0.

The reaction of the thermoplastic polyester with the diol (c) in reaction step (i) is preferably carried out in the presence of customary catalysts, for example those which are described hereinbelow. Preference is given to using catalysts based on metals for this reaction. The reaction in step (i) is preferably carried out in the presence of 0.1% to 2% by weight of catalysts, based on the weight of diol (c). The reaction in the presence of such catalysts is advantageous in order that the reaction may be carried out in the available short residence time in the reactor, for example a reaction extruder.

Useful catalysts for this reaction step (i) include for example tetrabutyl orthotitanate and/or tin(II) dioctoate, preferably tin dioctoate.

The polyester diol (b1) obtained as reaction product from (i) preferably has a molecular weight in the range from 1000 g/mol to 5000 g/mol. The melting point of the polyester diol obtained as reaction product from (i) is preferably in the range from 150° C. to 260° C. and especially in the range from 165 to 245° C.; that is, the reaction product of the thermoplastic polyester with diol (c) in step (i) comprises compounds having the specified melting point, which are used in the subsequent step (ii).

The reaction of the thermoplastic polyester with diol (c) in step (i) causes scissioning of the polymer chain of the polyester by diol (c) through transesterification. The reaction product of the TPU therefore has free hydroxyl end groups and is preferably further processed in the further step (ii) to form the actual product, the TPU.

The conversion of the reaction product from step (i) in step (H) is preferably effected by addition of a) isocyanate (a) and also (b2) polyether diols and/or polyester diols each having a melting point of less than 150° C. and a molecular weight of 501 to 8000 g/mol and also if appropriate further diols (c) having a molecular weight of 62 to 500, (d) catalysts and/or (e) auxiliaries to the reaction product from (i). The reaction of the reaction product with the isocyanate takes place via the hydroxyl end groups formed in step (i). The reaction in the step (ii) is preferably carried out at a temperature of 190 to 250° C. for a duration of preferably 0.5 to 5 min and more preferably 0.5 to 2 min, preferably in a reaction extruder and more preferably in the same reaction extruder in which step (i) was carried out. For example, the reaction of step (i) can take place in the first barrel sections of a customary reaction extruder and the corresponding reaction of step (ii) be carried out at a downstream point, i.e., downstream barrel sections, following the addition of components (a) and (b2). For example, the first 30% to 50% of the length of the reaction extruder can be used for step (i) and the remaining 50% to 70% for step (H).

The reaction in step (ii) is preferably carried out with an excess of isocyanate groups to isocyanate-reactive groups. The ratio of isocyanate groups to hydroxyl groups in reaction (ii) is preferably in the range from 1:1 to 1.2:1 and more preferably in the range from 1.02:1 to 1.2:1.

Reactions (i) and (ii) are preferably carried out in a commonly known reaction extruder. Such reaction extruders are described by way of example in the company publications of Werner & Pfleiderer or in DE-A 2 302 564.

The method of carrying out the preferred process is preferably such that at least one thermoplastic polyester, for example polybutylene terephthalate, is metered into the first barrel section of a reaction extruder and is melted at temperatures which are preferably between 180° C. to 270° C. and preferably in the range from 240° C. to 270° C., and, in a subsequent barrel section, a diol (c), for example butanediol, and preferably a transesterification catalyst are added, and the polyester is degraded at temperatures between 240° C. to 280° C. by the diol (c) to give polyester oligomers having hydroxyl end groups and molecular weights between 1000 to 5000 g/mol, and, in a subsequent barrel section, isocyanate (a) and (b2) isocyanate-reactive compounds having a molecular weight of 501 to 8000 g/mol and also if appropriate (c) diols having a molecular weight of 62 to 500, (d) catalysts and/or (e) auxiliaries are metered in, and then, at temperatures of 190 to 250° C., the construction to form the preferred thermoplastic polyurethanes is carried out.

In step (H), it is preferable for no (c) diols having a molecular weight of 62 to 500 to be introduced other than (c) diols present in the reaction product of (i) and having a molecular weight of 62 to 500.

In the region in which the thermoplastic polyester is melted, the reaction extruder preferably has neutral and/or reverse-conveying kneading blocks and reverse-conveying elements, and in the region where the thermoplastic polyester is reacted with the diol it preferably has mixing elements on the screw, and toothed disks, and/or toothed mixing elements in combination with reverse-conveying elements.

Downstream of the reaction extruder, the clear melt is typically fed by a gear pump to an underwater pelletizer, and pelletized.

The fraction of thermoplastic polyester in the end product, i.e., in the thermoplastic polyurethane, is preferably in the range from 5% to 75% by weight. The preferred thermoplastic polyurethanes are more preferably products of the reaction of a mixture comprising 10% to 70% by weight of the reaction product of (i), 10% to 80% by weight of (b2) and 10% to 20% by weight of (a), these weight percentages being based on the total weight of the mixture comprising (a), (b2), (d), (e) and the reaction product from (i).

The preferred thermoplastic polyurethanes preferably have the following structural unit (II):

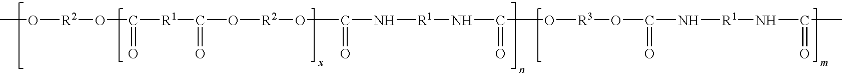

with the following meanings for R1, R2, R3 and X:
R1: carbonaceous scaffold having 2 to 15 carbon atoms, preferably an alkylene group having 2 to 15 carbon atoms and/or an aromatic radical having 6 to 15 carbon atoms,
R2: optionally branched alkylene group having 2 to 8 carbon atoms, preferably 2 to 6 and more preferably 2 to 4 carbon atoms, in particular —CH₂—CH₂— and/or —CH₂—CH₂—CH₂—CH₂—,
R3: a radical resulting from the use of polyether diols and/or polyester diols each having molecular weights between 501 g/mol and 8000 g/mol as (b2) or from the use of alkanediols having 2 to 12 carbon atoms for the reaction with diisocyanates,
X: an integer from 5 to 30,
n, m: an integer from 5 to 20.

The R1 radical is defined by the isocyanate used, the R2 radical by the reaction product of the thermoplastic polyester with the diol (c) in (i) and the R3 radical by the starting components (b2) and if appropriate (c) in the preparation of the TPUs.

The present invention also provides a process for producing nonwovens based on thermoplastic polyurethane, which comprises processing a thermoplastic polyurethane comprising an inorganic additive, at least 70%, preferably at least 90% and more preferably at least 99.9% of the particles of the inorganic additive having a maximum particle diameter smaller than 75%, preferably below 60% and more preferably below 50% of the fiber diameter of the thermoplastic polyurethane, by the meltblown or spunbond process to form the nonwoven.

The nonwovens comprising thermoplastic polyurethane can typically be produced from above-described thermoplastic polyurethane by the conventional meltblown process or spunbond process. Meltblown processes and spunbond processes are known to those skilled in the art.

The nonwovens which are formed in the processes generally differ in terms of their mechanical properties and their consistency. Nonwovens produced by the spunbond process are particularly stable both horizontally and vertically, but have an open-celled structure. Nonwovens produced by the meltblown process have a particularly dense network of fibers and hence form a very effective barrier to liquids. Meltblown nonwovens are preferred. To produce a TPU nonwoven by the meltblown process, a commercial plant for producing meltblown nonwovens can be used. Such plant is available from Reifenhauser of Germany for example. Typically, in a meltblown process, the TPU is melted in an extruder and fed by means of customary ancillaries such as melt pumps or filters to a spinning manifold. Here, the polymer generally flows through nozzles and, at the nozzle exit, is attenuated by an airstream to form a filament. The attenuated filaments are typically laid down on a drum or belt and forwarded.

A preferred embodiment utilizes a single-screw extruder having a compression ratio of 1:2-1:3.5 and particularly preferably 1:2-1:3. It is preferable to employ in addition a three-zone screw having a length to diameter (L/D) ratio of 25-30. The three zones are preferably equal in length. The three-zone screw preferably has throughout a constant pitch of 0.8-1.2 D and particularly preferably 0.95-1.05 D. The clearance between the screw and the barrel is >0.1 mm, preferably 0.1-0.2 mm. When a barrier screw is used as extruder screw, it is preferable to employ an overflow gap >1.2 mm. When the screw is equipped with mixing elements, these mixing elements are preferably not shearing elements.

The nonwoven plant is typically dimensioned such that the residence time of the TPU is as short as possible, i.e., <15 min, preferably <10 min and more preferably <5 min.

The TPU of the present invention is typically processed at temperatures between 180° C. and 250° C. and preferably between 200° C. and 230° C.

As already set out at the beginning, the inorganic additive can be incorporated in the thermoplastic polyurethane in the form of a concentrate comprising between 10% by weight and 60% by weight, more preferably between 20% by weight and 50% by weight, in particular between 25% by weight and 40% by weight of the inorganic additive, based on the total weight of the concentrate.

The nonwovens of the present invention are used for example as seals in the industrial sector, hygiene products, filters, medical/medicinal products, laminates and textiles, for example as plasters, wound dressings and bandages in the medical sector, as elastic elements in diapers and other hygiene articles, as elastic cuffs in apparel, as inliners in apparel, as backings for films, for example in the manufacture of water vapor permeable membranes, as a laminate for leather, as antislip protector for tablecloths, carpets, as antislip protector for socks, as decorative appliqué in the automotive interior, in textiles and sports shoes, curtains, furniture and the like.

To broaden the range of possible uses, the nonwovens of the present invention may be laminated with other materials, for example nonwovens, textiles, leather, paper.

The present invention accordingly also provides seals in the industrial sector, hygiene products, filters, medical/medicinal products, laminates and textiles, more preferably hygiene products and/or medical/medicinal products comprising the nonwovens of the present invention.

The examples which follow illustrate the invention.

### EXAMPLES

### Example 1

### Comparative Example

A TPU formed from 1000 g of a polybutanediol adipate esterol having an OH number of 56.2 and 122 g of 1,4-butanediol and 463 g of 4,4′MDI were melted in a capillary viscometer and subsequently spun at 210° C. by passing the fibers over a deflecting roller and winding them up on a rotating bobbin, controllable in its winding speed. To analyze spinability, the draw ratio was varied over time. The draw ratio is the ratio of the speed of the melt in the die to the wind-up speed of the filament. In addition, the thickness of the filament can be calculated from the draw ratio and the diameter of the die. The maximum draw ratio of the product was DR=815. The filament stuck together and was impossible to separate.

### Example 2

A TPU formed from 1000 g of a polybutanediol adipate esterol having an OH number of 56.2 and 122 g of 1,4-butanediol and 463 g of 4,4′MDI were melted with 3% by weight of a masterbatch consisting of Elastollan® 1180 A10 and 35% by weight of Celite® Superfine Superfloss silicon-oxygen compound (Celite Corporation) in a capillary viscometer and subsequently spun at 210° C. by passing the fibers over a deflecting roller and winding them up on a rotating bobbin, controllable in its winding speed. To analyze spinability, the draw ratio was varied over time. Surprisingly, the maximum draw ratio DR increased significantly on addition of the additive to DR=3200, i.e., the product was significantly better spinable. The fiber no longer stuck together.

### Example 3

Celite® Superfine Superfloss additive having the following particle size distribution:

10% of particles smaller than 1.4 μm, 50% of particles smaller than 4.7 μm and 90% of particles smaller than 11.8 μm
was processed with an Elastollan® 2280 A 10 (Elastogran GmbH, Germany) to form a concentrate by incorporating the inorganic additive on an extruder into the TPU and then pelletizing the polymer strand.

Elastollan® 2280 A 10 was subsequently blended with 3% of the concentrate produced, melted in a capillary viscometer and subsequently spun at 210° C. by passing the fibers over a deflecting roller and winding them up on a rotating bobbin, controllable in its winding speed.

Fibers having a linear density of 5 dtex, 22, dtex and 44 dtex were produced. These fibers range from 25 μm to 73 μm in diameter.

1. A fiber comprising a thermoplastic polyurethane and particles of an inorganic additive, wherein at least 70% of the particles of the inorganic additive have a maximum particle diameter smaller than 75% of the fiber diameter of the thermoplastic polyurethane.

2. A nonwoven material comprising the fiber according to claim 1.

3. The fiber according to claim 1 wherein the inorganic additive comprises silicon.

4. The fiber according to claim 1 wherein the inorganic additive comprises a silicate.

5. The fiber according to claim 1 wherein the inorganic additive comprises:
between 90% by weight and 95% by weight of SiO₂;
between 1% by weight and 5% by weight of Al₂O₃;
between 1% by weight and 5% by weight of Fe₂O₃;
between 0.1% by weight and 1% by weight of P₂O₅;
between 0.1% by weight and 1% by weight of TiO₂;
between 0.1% by weight and 2% by weight of CaO;
between 0.1% by weight and 2% by weight of MgO;
between 0.01% by weight and 3% by weight of Na₂O; and
between 0.01% by weight and 3% by weight of K2O.

6. The fiber according to claim 1 wherein a weight fraction of the inorganic additive in the thermoplastic polyurethane is between 0.1% by weight and 5% by weight, based on the total weight of the thermoplastic polyurethane comprising the inorganic additive.

7. (canceled)

8. The fiber according to claim 1 wherein the thermoplastic polyurethane has a crystallization temperature between 130° C. and 220° C. and is based on an aliphatic isocyanate.

9. The fiber according to claim 1 wherein the thermoplastic polyurethane is obtained by reacting (a) isocyanates with (b1) polyester diols having a melting point above 150° C., (b2) at least one of polyether diols and polyester diols wherein said at least one of polyether diols and polyester diols has a melting point below 150° C. and a molecular weight of 501 to 8000 g/mol, and also (c) diols having a molecular weight of 62 g/mol to 500 g/mol.

10. The fiber according to claim 1 wherein the thermoplastic polyurethane has a hardness between 65 Shore A and 95 Shore A.

11. The fiber according to claim 2 wherein the thermoplastic polyurethane is obtained by
(i) reacting a thermoplastic polyester with a diol (c) and then
(ii) reacting the reaction product from (i) comprising (b1) polyester diol having a melting point above 150° C. and also if appropriate (c) diol together with (b2) at least one of polyether diols and polyester diols wherein said at least one of polyether diols and polyester diols has a melting point below 150° C. and a molecular weight of 501 to 8000 g/mol and also if appropriate further (c) diols having a molecular weight of 62 to 500 g/mol with (a) isocyanate if appropriate in the presence of at least one of (d) catalysts and (e) auxiliaries.

12. The fiber according to claim 2 wherein the nonwoven has an ISO 9073-1 weight per unit area in the range from 5 to 500 g/m².

13. The fiber according to claim 2 wherein the nonwoven has an ISO 9073-2 thickness in the range from 0.01 to 5 millimeters (mm).

14. Seals in the industrial sector, hygiene products, filters, medical/medicinal products, laminates or textiles comprising the nonwoven according to claim 2.

15. The fiber according to claim 1 wherein the thermoplastic polyurethane is in a crosslinked state.

16. A process for producing nonwoven based on thermoplastic polyurethane, comprising processing a thermoplastic polyurethane and particles of an inorganic additive, wherein at least 70% of the particles of the inorganic additive have a maximum particle diameter smaller than 75% of the fiber diameter of the thermoplastic polyurethane, by a meltblown or spunbond process to form the nonwoven.

17. (canceled)

18. A process for producing a fiber based on a thermoplastic polyurethane, comprising processing a thermoplastic polyurethane and particles of an inorganic additive, wherein at least 70% of the particles of the inorganic additive have a maximum particle diameter smaller than 75% of the fiber diameter of the thermoplastic polyurethane, by melt spinning to form the fiber.

19. The process according to claim 18, comprising processing the thermoplastic polyurethane into fiber together with a crosslinker comprising isocyanate groups.

20. The process according to claim 16, comprising incorporating the inorganic additive in the thermoplastic polyurethane in the form of a concentrate comprising between 10% by weight and 60% by weight of the inorganic additive, based on the total weight of the concentrate.

21. The fiber according to claim 1 wherein at least 90% of the particles of the inorganic additive have a maximum particle diameter smaller than 75% of the fiber diameter of the thermoplastic polyurethane.
